(19) United States
(12) Patent Application Publication
(10) Pub. No.: US 2010/0281755 A1
(43) Pub. Date: Nov. 11, 2010

(54) Catfish baiting devices

(76) Inventor: Carl Lee Armour, Glenville, WV (US)

Correspondence Address: A&G Intellectual Property Group, LLC, PO Box 4254, Morgantown, WV, 26504, US

(21) Appl. No.: 12/660,948

(22) Filed: Mar. 8, 2010

Related U.S. Application Data
(60) Provisional application No. 61/215,410, filed on May 5, 2009.

(51) Int. Cl. A01K 97/04

(52) U.S. Cl. 43/42.06; 43/41; 43/4

(57) ABSTRACT

A first embodiment is a paste baiting device system comprised of one or more bait holders, a bait application housing, and a bait dispenser. The bait holders can be filled with paste bait commonly referred to as stink, dip, and punch baits from the bait dispenser. One or more bait holders can be secured at a time in the bait application housing during the baiting.

### CROSS-REFERENCE TO RELATED APPLICATIONS

This Application claims priority of Provisional Patent Application No. 61/215,410 filed on May 5, 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

### BRIEF DESCRIPTION OF THE SEVERAL VIEWS OF THE DRAWING

FIG. 1 is a perspective view and cross section view of a bait holder.

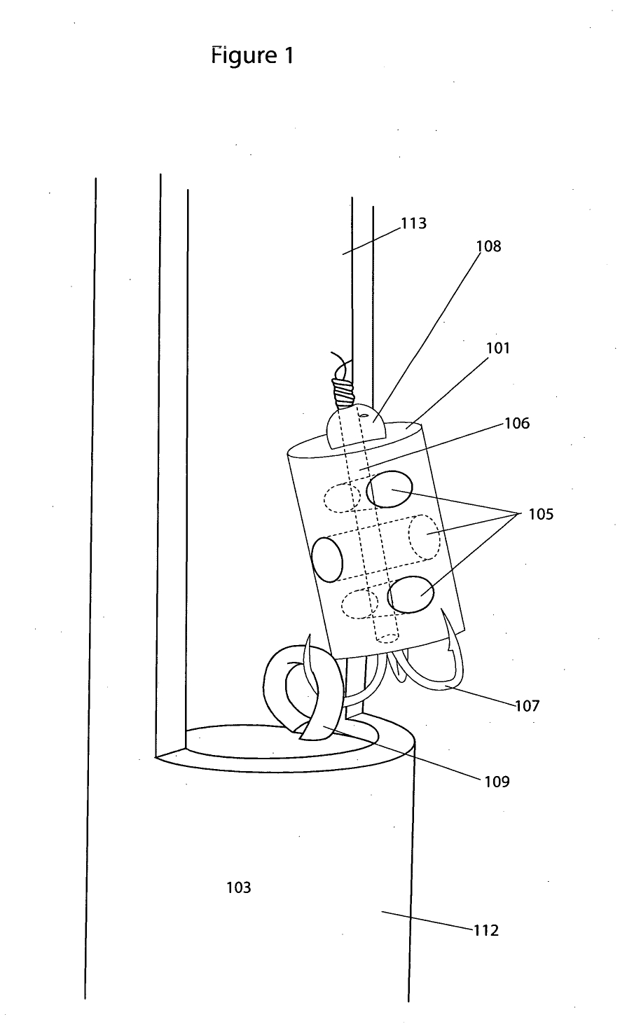

FIG. 2 is a perspective view of a bait application housing.

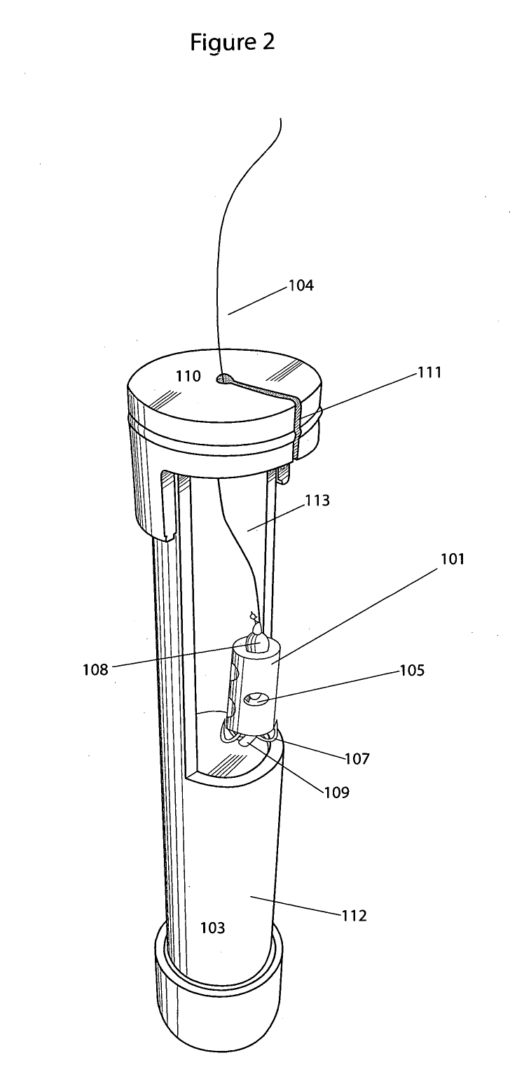

FIG. 3 is a perspective view of a bait application housing holding a bait holder and being loaded by a bait dispenser.

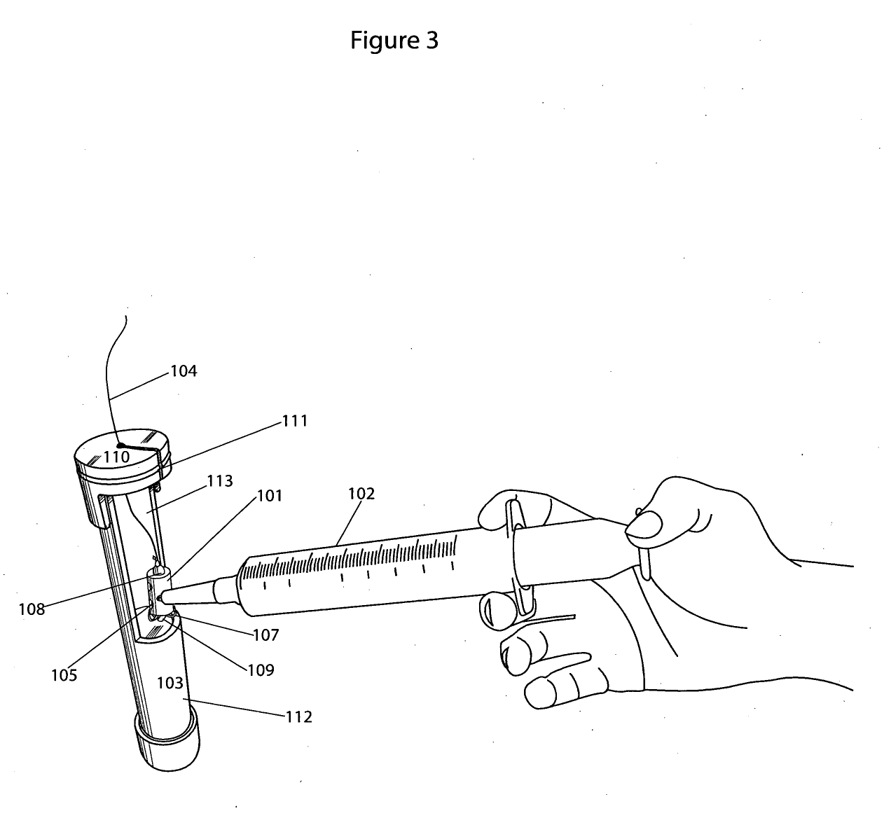

### DETAILED DESCRIPTION OF THE INVENTION

A first embodiment is a paste baiting device system comprised of one or more bait holders, a bait application housing, and a bait dispenser. The bait holders 101 can be filled with paste bait commonly referred to as stink, dip, and punch baits from the bait dispenser 102. One or more bait holders can be secured at a time in the bait application housing 103 during the baiting. Any paste-like bait such as, but not limited to, stink, punch, and dip baits can be added to the bait holders. The devices in the system allow for less mess, especially with paste baits, and can reduce or eliminate the addition of human scents and other odors from baiting because a user does not touch the bait or bait holder during application. Also a bait holder can remain on the fishing line 104 during the application of bait and bait can be applied quicker to allow more time for fishing.

The bait holders can be comprised of plastomers such as polyurethane foam or polyvinylchloride foam or a blend of one or both where a blend is about 50% or more of polyvinylchloride or polyurethane foam and any other additional material. The bait holders can be various shapes such as cylinder. Ooze holes 105 can be added perpendicular to its long axis. The holders can also have a central channel cut lengthwise to hold bait and 106 to enable a fishing line to extend through so that a hook 107 can be added to one end and the other end of the fishing line can be attached to a fishing pole. Bait can be added to one or more ooze holes and/or the central channel. With use of a dispenser the amount of bait can be controlled so excess bait will not fall off during casting. Bait falling off a bait holder can hit multiple spots which hinders the ability to create a stationary source of a scent field. The ooze holes can slowly release bait to form a stationary source of scent for foraging fish to home in on to be caught. The bait holder can also have a cap, 108 such as a bead, to be added to the top of the central channel to keep the bait holder in place at the end of a fishing line. The bead can be held by any standard means such as by a knot such as a slip bobber knot or any other knot known by one skilled in the art.

A bait application housing can secure the bait holder while bait is added to the bait holder. A bait application housing can be made of any durable material such as metal, plastic, or wood. The bait application housing has a chamber 113 in which a bait holder can be held during the baiting. Additionally, a securing mechanism 109 such as an eye hook can be added to one end of the chamber in order to secure the hook proceeding through the bait holder, therefore securing the bait holder to the bait application housing. Securing a bait holder can allow for the application of bait from the bait dispenser to the bait holder without the need for holding or touching the bait by hand. The user can maintain the desired tension on the line attached to the holder by wrapping it around the back of the housing and holding it in place by the hand holding the housing or by using any other securing means such as tape. The end opposite the securing mechanism can be open for easy entering or exiting of the bait holder or can be capped 110. This end can be the first end of the bait application housing or the chamber. The first end can have a capped end with a slot for a fish line to enter 111. An alternative embodiment could have a first end capped in a holding design such as a half moon shaped end cap with a half moon hole or any other design one skilled in the art can manipulate the variations for any holding design without difficulties or experimentation. While the first end of the bait application housing or chamber allows for the entrance of a fishing line the second end, the end with the securing mechanism, can be sealed. The bait application housing can further have a handle 112 attached to the second end to function as a gripping area. The handle can be hollow to allow for floating should the bait application housing be dropped into the water. Also the handle and or the bait application housing can be brightly colored so that it is easy to spot if dropped in the water.

The bait dispenser can be any device capable of delivering a paste bait such as a spackling gun, knife, a syringe, or any other device one skilled in the art would use to deliver a paste bait. A syringe could further be sheathed to prevent spillage and to control the odor of catfish baits. A 60 cc syringe applicator could be modified with removable tips so that the preferred diameter can be chosen depending on the type of bait holder. Additionally or alternatively, the dispenser can have a compression held insert with an end which can be cut to a chosen diameter or it can be removed depending on the type of bait holder used by a fisherman. A bait holder with a central core and ooze hole can hold bait for about 30 minutes depending on the water conditions.

These terms and specifications, including the examples, serve to describe the invention by example and not to limit the invention. It is expected that others will perceive differences, which, while differing from the foregoing, do not depart from the scope of the invention herein described and claimed. In particular, any of the function elements described herein may be replaced by any other known element having an equivalent function.

What is claimed is:

1. A paste baiting system comprising
one or more plastomer bait holders wherein the bait holders have central channels to hold one or more paste baits and allow for a fishing line to enter a first end of the bait holder and exit a second end of the holder to connect the fishing line to a hook at the second end;
a bait dispenser to add one or more paste baits to said bait holders; and
a bait application housing with a first end connected to a chamber for retaining the bait holder during application of the paste bait wherein the chamber has a securing mechanism to retain the bait holder in place during the bait application.

2. The paste baiting system of claim 1 wherein the bait holders have one or more ooze holes.

3. The paste baiting system of claim 1 wherein the bait holders have a cap to hold the fishing line in place.

4. The paste baiting system of claim 1 wherein the bait dispenser is a 60 cc syringe applicator with one or more removeable tips for the preferred diameter of application.

5. The paste baiting system of claim 4 wherein the bait dispenser has a compression held insert with an end cut to a chosen diameter.

6. The paste baiting system of claim 1 wherein the bait dispenser is further comprised with a compression held insert with an end cut to a chosen diameter.

7. The paste baiting system of claim 1 wherein the securing mechanism is an eye hook.

8. The paste baiting system of claim 1 wherein the first end of the bait application housing is open.

9. The paste baiting system of claim 1 wherein the first end of the bait application housing is capped with a slot cut into the capped end for a fishing line to pass in and out of the bait application housing.

10. The paste baiting system of claim 1 the bait application housing further comprising a second end containing a handle.

11. The paste baiting system of claim 10 wherein said handle is hollow.

12. The paste baiting system of claim 11 wherein said handle is brightly colored.

13. A baiting system comprising
a chamber wherein the chamber has a securing mechanism and the first end of the chamber allows for entrance of a fishing line while the second end is sealed; and
one or more plastomer bait holders wherein the bait holders have central channels to hold one or more paste baits and allow for a fishing line to enter a first end of the bait holder and exit a second end of the holder to connect the fishing line to a hook at the second end and ooze holes;
wherein the bait holder can enter the first end of the chamber and be secured to the securing mechanism so that a paste bait can be added to the bait holder with a fishing line and hook already added without a user having to hold the bait holder during application.

14. The baiting system of claim 13 wherein the bait holder is further comprised of a cap to hold the fishing line in place.

15. The baiting system of claim 13 wherein the first end of the chamber is open.

16. The baiting system of claim 13 wherein the first end of the chamber is capped with a slot cut into the capped end for a fishing line to be held.

17. The baiting system of claim 13 wherein the second end of the chamber contains a handle.

18. The paste baiting system of claim 17 wherein the handle is hollow.

19. The paste baiting system of claim 17 wherein the handle is brightly colored.

20. The paste baiting system of claim 14 wherein the cap has a holding design to hold the fishing line.
